(19) United States
(12) Patent Application Publication
(10) Pub. No.: US 2026/0361258 A1
(43) Pub. Date: Nov. 12, 2026

(54) PORTABLE SOLAR-POWERED POWER GENERATION ASSEMBLY

(71) Applicants: Laura Semien, Opelousas, LA (US); Vantashia Semien, Opelousas, LA (US)

(72) Inventors: Laura Semien, Opelousas, LA (US); Vantashia Semien, Opelousas, LA (US)

(21) Appl. No.: 19/666,003

(22) Filed: May 1, 2026

Related U.S. Application Data
(60) Provisional application No. 63/803,379, filed on May 9, 2025.

(51) Int. Cl. H02S 10/40; H02J 7/35; H02S 10/20; H02S 20/10; H02S 30/20

(52) U.S. Cl. CPC H02S 10/40; H02J 7/35; H02S 10/20; H02S 20/10; H02S 30/20

(57) ABSTRACT

A portable solar-powered power generation assembly that includes a housing enclosing power generation circuitry, power management circuitry, and one or more rechargeable batteries. A foldable solar panel is mounted to the housing. The solar panel may include a middle panel fixed to the housing and side panels pivotally coupled to the middle panel, wherein the side panels are movable between open and folded positions for operation, storage, and transportation. The assembly further includes one or more power output interfaces disposed on the housing, including AC power sockets, DC outlets, USB ports, and USB-C charging ports configured to support multiple charging protocols. The housing further includes at least one coupling interface configured to detachably receive interchangeable mounting units, including a C-clamp for attachment to supporting structures and a ground stake for insertion into the ground.

### CROSS REFERENCE TO RELATED APPLICATIONS

This application claims priority from a U.S. Provisional Patent Appl. No. 63/803,379, filed on May 9, 2025, which is incorporated herein by reference in its entirety.

### FIELD OF INVENTION

The present invention relates generally to a solar-powered portable power generation assembly. More particularly, the present invention relates to a portable power generation assembly that can be installed in the ground and incorporates one or more power outlets for connecting external electronic devices.

### BACKGROUND

Electricity is an essential requirement of the modern world. People nowadays use a variety of electronic devices in their day-to-day lives, all of which are powered by electricity. Some of these devices may be essential for daily living, while others may be used for entertainment and other purposes. The use of batteries has enhanced the portability of electronic devices, and users commonly carry multiple electronic devices outdoors, such as smartphones, music players, and the like. However, battery capacity is limited, and such portable battery-powered electronic devices must be recharged frequently. For this reason, publicly accessible power outlets for recharging portable electronic devices are made available at various public places.

However, publicly accessible power outlets are not available everywhere. For example, in gardens, remote locations, hilly areas, and similar environments, power outlets may be unavailable, requiring users to arrange their own power generation units. Portable power generators are known in the art; however, such generators are often heavy, bulky, and inconvenient to transport.

Accordingly, there exists a need for a portable power generation assembly that is compact, lightweight, and easy to deploy.

### SUMMARY OF THE INVENTION

The following presents a simplified summary of one or more embodiments of the present invention to provide a basic understanding of certain features and advantages thereof. This summary is not an exhaustive overview of all contemplated embodiments and is not intended to identify key or critical elements of the invention or to delineate the scope of the claims. Rather, it introduces selected concepts that are further described in the detailed description.

The principal object of the present invention is to provide a solar-based power generation assembly that is compact, portable, and lightweight.

Another object of the present invention is to provide a power generation assembly that can be easily secured in position.

Another object of the present invention is to provide a power generation assembly equipped with multiple power outlets.

Another object of the present invention is to provide a power generation assembly that is economical to manufacture.

Another object of the present invention is to provide a power generation assembly that is cost-effective in use and utilizes renewable energy for power generation.

Another object of the present invention is to provide a power generation assembly including a standard AC socket as well as a USB socket for powering or charging electronic devices.

### SUMMARY OF THE INVENTION

The present invention relates to a portable solar-powered power generation assembly configured to provide a compact, lightweight, and versatile source of electrical power for outdoor, remote, emergency, and recreational use. The assembly is designed to generate electrical energy from sunlight and selectively supply usable power to a variety of external electronic devices.

In an exemplary embodiment, the assembly includes a housing enclosing power generation circuitry, power management circuitry, protective circuitry, and one or more rechargeable batteries. A solar panel is mounted to the housing and configured to convert solar energy into electrical energy. The generated energy may be supplied directly to connected devices, stored within the rechargeable batteries, or both.

In one aspect, the solar panel may be foldable to reduce the overall size of the assembly during storage and transportation. The solar panel may include a middle panel mounted to the housing and one or more side panels pivotally coupled to the middle panel. The side panels may be movable between open and folded positions and may further be angularly adjustable to maximize sunlight exposure. In certain embodiments, the middle panel may also be rotatable or pivotable relative to the housing for optimizing the orientation of the solar panel.

In another aspect, the assembly includes one or more power output interfaces disposed on the housing. Such interfaces may include AC power sockets, DC output ports, USB charging ports, USB-C ports, fast-charging ports, or combinations thereof. The power management circuitry may regulate voltage and current, perform DC-to-DC conversion, DC-to-AC conversion, battery charging, and other electrical conditioning functions for compatibility with different devices.

In a further aspect, the housing may include at least one coupling interface configured to detachably receive interchangeable mounting units. The mounting units may include, for example, a C-clamp for attachment to tables, rails, poles, benches, or similar supporting structures, and a ground stake for insertion into soil or other ground surfaces. Such interchangeable mounting arrangements permit stable deployment of the assembly in diverse environments.

In certain embodiments, the housing and output interfaces may be weather-resistant or waterproof, and may include protective covers to prevent ingress of dust and moisture. Safety features may further include surge protection, overcurrent protection, overvoltage protection, short-circuit protection, thermal protection, and battery management functions.

Accordingly, the disclosed portable solar-powered power generation assembly provides a self-contained renewable energy solution that is portable, easy to deploy, compatible with multiple electronic devices, and adaptable to a wide range of applications.

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a perspective view of a power generation assembly, according to an exemplary embodiment of the present invention.

FIG. 2 illustrates the solar panel of the power generation assembly in a folded state, according to an exemplary embodiment of the present invention.

FIG. 3 illustrates the housing of the power generation assembly including one or more power outlets, according to an exemplary embodiment of the present invention.

FIG. 4 illustrates a twist and lock coupling interface, according to an exemplary embodiment of the present invention.

FIG. 5 illustrates a C-clamp as a mounting unit, according to an exemplary embodiment of the present invention.

FIG. 6 illustrates a ground stake as a mounting unit, according to an exemplary embodiment of the present invention.

### DETAILED DESCRIPTION

The subject matter of the present invention will now be described more fully with reference to the accompanying drawings, which form a part of this disclosure and illustrate specific exemplary embodiments. However, it should be understood that the subject matter may be embodied in various forms and is not limited to the specific embodiments set forth herein. Rather, these embodiments are provided by way of example to convey the scope of the invention. It is intended that the claims encompass a broad range of subject matter, including methods, devices, components, and systems. Accordingly, the following detailed description is not intended to be taken in a limiting sense.

As used herein, the term “exemplary” is intended to mean “serving as an example, instance, or illustration.” Any embodiment described as “exemplary” should not be construed as preferred or more advantageous over other embodiments. Similarly, the expression “embodiments of the present invention” does not imply that all embodiments must include all features, advantages, or modes of operation described.

The terminology used herein is for the purpose of describing particular embodiments only and is not intended to be limiting. As used herein, the singular forms “a,” “an,” and “the” include plural references unless the context clearly dictates otherwise. Furthermore, the terms “comprises,” “comprising,” “includes,” and/or “including” specify the presence of stated features, integers, steps, operations, elements, or components, but do not preclude the presence or addition of one or more other features, integers, steps, operations, elements, components, and/or groups thereof.

The following detailed description sets forth the best currently contemplated modes for carrying out exemplary embodiments of the invention. This description is not intended to be limiting, but rather to illustrate the general principles of the invention. The claims of any issued patent will define the scope of the invention.

The present invention pertains to a solar-based portable power generation assembly that is compact, lightweight, and easily transportable. The portable power generation assembly includes a foldable solar panel, thereby making the assembly compact and convenient to carry. Multiple mounting options, including a C-clamp and a ground stake, make the invention versatile and enable it to be easily secured to any suitable supporting structure.

The portable power generation assembly incorporates multiple types of power outlets, thereby making the invention compatible with a variety of electronic devices. For example, both AC-powered and DC-powered devices may be used with the disclosed portable power generation assembly. Different voltage outputs, such as USB sockets, may be provided for charging smartphones, music players, and similar devices. The disclosed portable power generation assembly may further support different charging protocols and power-delivery standards known in the art for faster charging.

In an exemplary embodiment, the portable power generation assembly may support one or more charging protocols for delivering power to connected electronic devices in an efficient manner. Such charging protocols may include standard USB charging, USB Battery Charging (BC), Qualcomm® Quick Charge™, USB Power Delivery (USB-PD), adaptive fast charging, programmable power supply protocols, and other charging standards known in the art. By supporting multiple charging protocols, the disclosed assembly may automatically detect the connected device and supply a compatible output voltage and current, thereby enabling faster charging of smartphones, tablets, laptops, wearable devices, cameras, music players, and similar portable electronics.

In one implementation, the assembly may provide selectable or automatic output levels such as 5V, 9V, 12V, 15V, and 20V DC through one or more USB ports, including USB-A and USB-C connectors. A control circuit may be provided to communicate with the connected device and regulate the charging parameters according to the supported protocol.

The charging control system may further include protective features such as overcurrent protection, overvoltage protection, thermal shutdown, reverse polarity protection, battery management, and foreign object detection, thereby ensuring safe operation during charging.

Advantageously, support for multiple charging protocols increases compatibility with modern electronic devices and improves charging speed, efficiency, and user convenience in outdoor, remote, or emergency environments.

The disclosed assembly may also include one or more rechargeable batteries configured to be charged by the energy generated from the solar panel of the disclosed portable power generation assembly. The incorporation of the rechargeable battery may provide power backup when sunlight is unavailable or insufficient. Moreover, the user may not be required to carry a separate power bank. Thus, the portable power generation assembly provides a cost-effective, compact, and self-sustaining power solution.

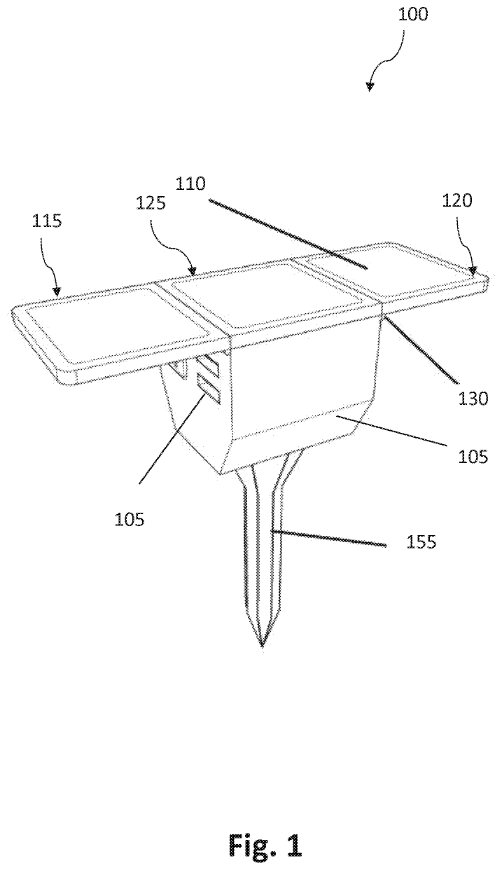

Referring to FIG. 1, a perspective view of the disclosed portable power generation assembly is illustrated using a ground stake as a mounting option. The portable power generation assembly 100 includes a housing 105 configured to enclose electronic components, circuitry, and one or more batteries. In an exemplary embodiment, the housing 105 may be weather-resistant and waterproof for outdoor use.

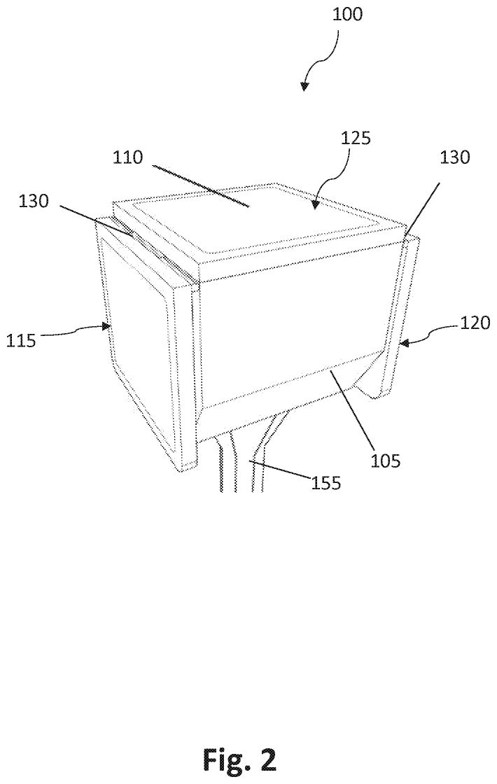

Mounted on an upper portion of the housing 105 is a solar panel 110 configured to generate electricity from solar energy. The solar panel 110 is positioned to face upwardly, wherein such orientation allows maximum exposure to sunlight. In an exemplary embodiment, the solar panel 110 comprises at least three panel sections, namely a left panel 115, a right panel 120, and a middle panel 125. The left panel 115 and the right panel 120 are pivotally coupled to the middle panel 125 through hinge joints 130. The hinge joints 130 allow the left and right panels 115, 120 to pivot downwardly from an open position to a folded position. FIG. 2 illustrates the solar panel 110 in the folded state.

Accordingly, a relatively large and elongated solar panel may be folded into a compact configuration for convenient storage and transportation. In addition to folding for storage, the angular positions of the left panel 115 and the right panel 120 relative to the middle panel 125 may be selectively adjusted to increase exposure to sunlight and improve power generation efficiency.

It is to be understood that the illustrated embodiment shows three panel sections; however, more than three panel sections are within the scope of the present invention. Further, the solar panel 110 may be formed using lightweight materials to enhance portability and ease of handling. In certain implementations, the left panel 115 and the right panel 120 may be rotatable relative to the middle panel 125, thereby allowing selective angular adjustment for maximizing exposure to sunlight. The middle panel 125 may further be rotatable or pivotable relative to the housing 105 to permit adjustment of the inclination angle of the middle panel 125 for optimum solar exposure under varying sun positions and environmental conditions.

In various exemplary embodiments, the solar panel 110 of the portable power generation assembly may comprise any photovoltaic panel suitable for converting solar radiation into electrical energy. The solar panel 110 may include monocrystalline silicon panels, polycrystalline silicon panels, thin-film solar panels, amorphous silicon panels, copper indium gallium selenide (CIGS) panels, cadmium telluride (CdTe) panels, perovskite-based panels, or combinations thereof. Selection of the panel type may depend upon desired efficiency, weight, flexibility, manufacturing cost, and intended outdoor operating conditions.

In one preferred embodiment, monocrystalline silicon panels may be used due to their relatively high conversion efficiency, compact size, and reliable long-term performance. Polycrystalline panels may be employed as a cost-effective alternative while still providing satisfactory energy generation. Thin-film or flexible photovoltaic panels may be particularly suitable where reduced weight, bendability, or impact resistance is desired. Such flexible panels may be integrated into foldable sections of the assembly to enhance portability.

The solar panel 110 may include a tempered glass top layer, transparent polymer coating, anti-reflective coating, or laminated protective sheet to protect the photovoltaic cells from dust, moisture, ultraviolet radiation, scratches, and mechanical impacts. In lightweight embodiments, polymer composite covers may be used in place of glass to reduce total assembly weight.

In certain embodiments, each panel section may operate independently and may be electrically connected in series, parallel, or a hybrid series-parallel arrangement to obtain a desired output voltage and current. Bypass diodes, blocking diodes, and maximum power point tracking (MPPT) circuitry may be incorporated to improve charging efficiency and reduce power loss due to shading or mismatched illumination conditions.

The solar panel 110 may be configured to generate outputs suitable for charging internal batteries and powering external devices, such as 5V USB outputs, 12V DC outputs, 24V DC outputs, or AC outputs through an inverter. Total wattage capacity may vary depending on the intended use, and may range, for example, from about 10 watts to about 500 watts or more.

Thus, the use of different photovoltaic technologies and modular panel arrangements enables the disclosed portable power generation assembly to be customized for recreational use, emergency backup, camping, military deployment, remote fieldwork, and general outdoor charging applications.

The middle panel 125 of the solar panel 110 may be mounted to the housing 105. The housing 105 may enclose power generation and power management circuitry configured to harness solar energy generated by the solar panel 110 and convert the same into a usable electrical form. For example, the voltage and current produced by the solar panel 110 may be regulated, conditioned, and converted to predetermined standard output levels suitable for charging and powering external devices.

In an exemplary embodiment, the power management circuitry may include one or more charge controllers, voltage regulators, current regulators, inverters, converters, transformers, battery management systems, and protection modules. Such circuitry may facilitate DC-to-DC conversion, DC-to-AC conversion through an inverter, and AC-to-DC conversion where auxiliary charging input is provided. The circuitry may further permit stepping up or stepping down voltage levels as required for different output interfaces.

By virtue of the foregoing arrangement, the assembly may provide multiple power outlets having different electrical configurations. For example, the assembly may include a standard 110V AC outlet, 220V AC outlet, 5V DC USB output, USB fast-charging ports, 12V DC accessory ports, USB-C Power Delivery ports, and similar power interfaces for a variety of electronic devices.

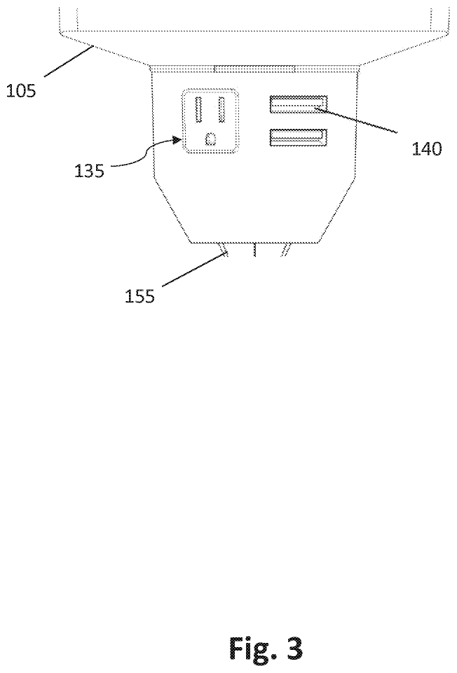

The power socket interfaces may be disposed on one or more sidewalls of the housing 105 for convenient user access. For example, FIG. 3 illustrates a sidewall of the housing 105 having a three-pin AC power socket 135 and two USB ports 140. However, the number, arrangement, size, and types of power outlets may vary without departing from the scope of the present invention.

In certain embodiments, the housing 105 may further include status indicators, digital displays, battery charge indicators, output selection switches, overload reset switches, wireless charging pads, and control buttons for enhanced user convenience and monitoring of operating conditions.

It is to be noted that the power socket interfaces may be configured to be water-resistant or waterproof so as to prevent ingress of moisture, water, or other contaminants. Suitable protective covers, flaps, caps, or sealing members may be provided for the respective power sockets to further prevent the ingress of dust, dirt, and moisture when the sockets are not in use. Each power socket may also be labeled with its corresponding electrical specification, such as 110V AC for a three-pin socket, 220V AC where applicable, 5V DC USB output, USB-C Power Delivery rating, or other relevant output parameters, thereby enabling safe and convenient user operation.

One or more batteries, preferably rechargeable batteries, may be enclosed within the housing 105. The rechargeable batteries may provide power backup when sunlight is unavailable or insufficient for direct power generation. Each of the one or more batteries may include a plurality of battery cells connected in series, parallel, or a combination thereof to obtain a desired voltage and storage capacity. The total battery capacity of the assembly may vary without departing from the scope of the present invention.

Examples of suitable batteries may include lithium-ion batteries, lithium iron phosphate (LiFePO4) batteries, lithium polymer batteries, sealed lead-acid batteries, nickel-metal hydride batteries, or any other suitable rechargeable energy storage devices known in the art. The selection of battery type may depend upon desired weight, cost, charging speed, safety, cycle life, and intended operating conditions.

The disclosed assembly may further include battery charging circuitry configured to charge the batteries, wherein the charging circuitry may also be enclosed within the housing 105. The batteries may be charged using electricity generated by the solar panel 110 through the power generation circuitry. Additionally, the batteries may be charged using electricity supplied from an external source, such as a domestic wall outlet, generator, vehicle power outlet, or other auxiliary power source.

Accordingly, the disclosed assembly may also function as a portable power bank or backup energy station, with the added advantage of multiple charging interfaces including solar charging and conventional wall-outlet charging. In certain embodiments, the assembly may automatically switch between solar charging, battery discharge mode, and external charging mode depending upon power availability and user requirements.

The assembly may further include at least one coupling interface configured to interchangeably receive and secure one or more mounting units. The mounting units may be used to fasten or support the disclosed assembly on any suitable supporting structure. By providing interchangeable mounting arrangements, the assembly may be conveniently deployed in a variety of environments and usage conditions.

Multiple types of mounting units may be provided for engagement with the coupling interface depending upon the intended supporting structure. For example, the mounting units may include a C-clamp for attachment to tables, railings, poles, benches, fences, or similar structures, and a ground stake for insertion into soil, sand, grass, or other outdoor surfaces. Additional mounting units, such as suction mounts, magnetic mounts, tripod mounts, wall brackets, strap mounts, hook mounts, or vehicle mounts, may also be used without departing from the scope of the present invention.

In an exemplary embodiment, the coupling interface may be disposed on a bottom portion of the housing 105. However, it is to be understood that the coupling interface may additionally or alternatively be provided on one or more sidewalls, rear surfaces, or combinations thereof. Multiple coupling interfaces located at different positions may increase mounting flexibility and allow the assembly to be oriented in a desired direction for improved solar exposure and user access.

The coupling interface may comprise threaded sockets, twist-lock connectors, bayonet fittings, slide rails, latch mechanisms, snap-fit couplings, quick-release connectors, pin-and-slot arrangements, or any other releasable fastening mechanism known in the art. Accordingly, the provision of multiple and different coupling interfaces may render the disclosed assembly more versatile by providing users with various options for mounting and positioning the assembly.

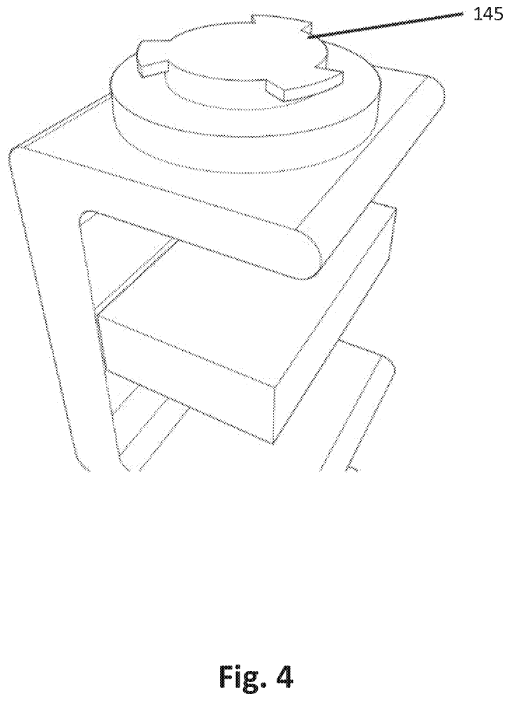

FIG. 4 illustrates a twist-and-lock mechanism 145 configured as a coupling interface for detachably securing a mounting unit to the housing 105. The coupling interface may include two cooperating members, wherein a first member is provided on the mounting unit and a second corresponding member is provided on a bottom portion of the housing 105. The two members may be aligned and engaged with one another, after which the housing 105 may be rotated in a predetermined direction relative to the mounting unit so as to lock the coupling interface. Such engagement securely fastens the mounting unit to the housing 105.

To remove the mounting unit, the housing 105 may be rotated in an opposite direction relative to the mounting unit until the locked engagement is released, whereupon the mounting unit may be separated from the housing 105. Accordingly, different types of mounting units may be interchangeably coupled to the housing 105 through the coupling interface, thereby enhancing versatility and ease of use.

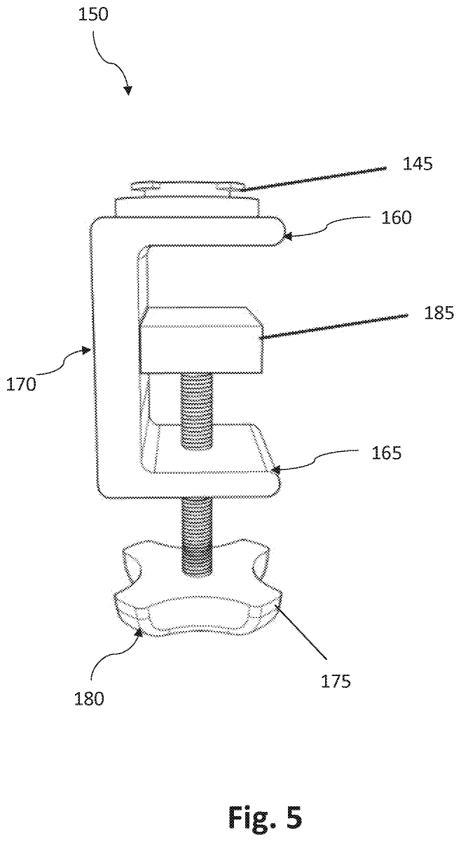

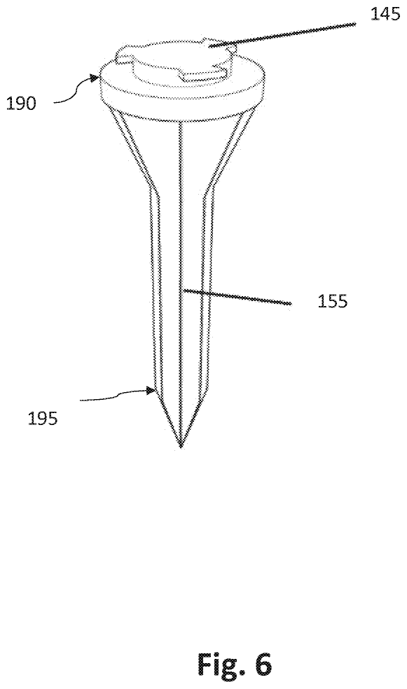

FIG. 5 illustrates a C-clamp 150 configured as one exemplary mounting unit, while FIG. 6 illustrates a ground stake 155 configured as another exemplary mounting unit. The C-clamp 150 may be used for attachment to rails, tables, poles, benches, fences, and similar structures, whereas the ground stake 155 may be inserted into soil, sand, grass, or other penetrable surfaces for outdoor deployment.

It is to be understood that only one exemplary type of coupling interface has been specifically described herein and illustrated in the drawings. However, any suitable type of detachable coupling interface, including threaded couplings, bayonet mounts, latch couplings, slide-lock mechanisms, snap-fit connectors, pin-and-slot systems, magnetic couplings, or quick-release interfaces, may be used without departing from the scope of the present invention.

Referring to FIG. 5, a C-clamp 150 is illustrated having a member of the coupling interface 145 provided at an upper portion thereof, and a bolt 175 inserted through a lower plate 165 from a bottom side thereof. The C-clamp 150 is generally C-shaped and includes an upper plate 160 and a lower plate 165, each extending from a base plate 170 so as to define a substantially C-shaped configuration.

The lower plate 165 may include a threaded aperture through which the bolt 175 is rotatably inserted from the underside of the lower plate 165. A proximal end of the bolt 175 may include a head 180, knob, or handle for manual rotation, while a distal end of the bolt 175 may include a bracket 185, pad, or pressure plate configured to engage a supporting surface.

In use, an edge portion of a supporting structure, such as a tabletop, railing, bench, shelf, fence, pole adapter, or similar structure, may be positioned between the bracket 185 and the upper plate 160. Thereafter, the bolt 175 may be rotated so as to advance the bracket 185 toward the supporting structure, thereby clamping the supporting structure between the bracket 185 and the upper plate 160 and securely fastening the mounting unit in place.

In certain embodiments, the bracket 185 may include a non-slip surface, rubber pad, pivoting contact plate, or cushioned member to improve grip and reduce damage to the supporting structure. The bolt 175 may further include coarse or fine threads for rapid adjustment or increased clamping force.

Once the C-clamp 150 is secured to the supporting structure, the portable power generation assembly may be coupled thereto through the coupling interface 145, thereby allowing the assembly to be stably mounted above ground level for improved sunlight exposure and convenient user access.

Referring to FIG. 6, a ground stake 155 configured as a mounting unit is illustrated. The ground stake 155 may include a head portion 190, wherein one member of the coupling interface 145 is integrally formed on or secured to an upper surface of the head portion. A distal end 195 of the ground stake 155 may be tapered, conical, pointed, or otherwise shaped to facilitate penetration into the ground.

The distal end of the ground stake 155 may be inserted into soil, sand, grass, mud, gravel, or other penetrable terrain while force is applied to the head portion, either manually or with the aid of a tool. Once the ground stake 155 is stably positioned, the housing 105 of the portable power generation assembly may be coupled to the head portion of the ground stake 155 through the coupling interface 145.

ground stake 155 provides a convenient option for securing the disclosed assembly substantially anywhere on ground surfaces where conventional supporting structures may be unavailable or unsuitable. For example, during picnics, camping, trekking, hiking, fishing, gardening, beach activities, emergency situations, military deployment, or remote outdoor work, a user may easily secure the disclosed assembly to the ground for stable operation and solar charging.

In certain embodiments, the ground stake 155 may be fabricated from metal, reinforced polymer, composite material, or corrosion-resistant material to withstand outdoor environmental conditions. The head portion may further include foot pads, hammering surfaces, grip formations, folding handles, or rotational features to assist insertion and removal from the ground.

In some implementations, the ground stake 155 may be detachable, telescopic, segmented, foldable, or adjustable in length to improve portability and accommodate different ground conditions. Accordingly, the ground stake mounting unit enhances the mobility and practical utility of the portable power generation assembly in outdoor environments.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A portable solar-powered power generation assembly, comprising:
a housing;
one or more electrical components enclosed within the housing;
a solar panel mounted to the housing and configured to generate electrical energy from sunlight;
one or more power output interfaces provided on the housing for supplying power to external electronic devices; and
at least one coupling interface provided on the housing and configured to detachably receive one or more interchangeable mounting units for securing the assembly to a supporting structure.

2. The assembly of claim 1, wherein the solar panel is foldable between an open position and a compact folded position.

3. The assembly of claim 2, wherein the solar panel comprises a middle panel mounted to the housing, a left panel pivotally coupled to the middle panel, and a right panel pivotally coupled to the middle panel.

4. The assembly of claim 1, wherein the one or more power output interfaces comprise at least one AC socket and at least one USB charging port.

5. The assembly of claim 1, further comprising one or more rechargeable batteries enclosed within the housing.

6. The assembly of claim 5, wherein the one or more rechargeable batteries are chargeable by electricity generated from the solar panel.

7. The assembly of claim 1, wherein the coupling interface comprises a twist-and-lock mechanism including a first coupling member provided on the housing and a second coupling member provided on the mounting unit.

8. The assembly of claim 1, wherein the one or more interchangeable mounting units include a C-clamp configured for attachment to an edge of a supporting structure.

9. The assembly of claim 1, wherein the one or more interchangeable mounting units include a ground stake configured for insertion into soil or other ground surfaces.

10. A method of generating portable electrical power using a solar-powered power generation assembly, the method comprising:
providing a housing having power management circuitry and one or more power output interfaces;
deploying a solar panel mounted to the housing to an open position;
exposing the solar panel to sunlight to generate electrical energy;
processing the generated electrical energy through the power management circuitry; and
supplying electrical power through the one or more power output interfaces to at least one external electronic device.

11. The method of claim 10, further comprising folding one or more side panels of the solar panel into a compact position for storage or transportation.

12. The method of claim 10, further comprising charging one or more rechargeable batteries enclosed within the housing using electrical energy generated by the solar panel.

13. The method of claim 10, further comprising charging the at least one external electronic device through a USB port, USB-C port, or AC socket.

14. The method of claim 10, further comprising detachably coupling a mounting unit to a coupling interface provided on the housing.

15. The method of claim 14, wherein the mounting unit comprises a C-clamp, and the method further comprises securing the C-clamp to a supporting structure.

16. The method of claim 14, wherein the mounting unit comprises a ground stake, and the method further comprises inserting the ground stake into a ground surface.

17. The method of claim 16, further comprising coupling the housing to the ground stake after the ground stake is stably positioned in the ground surface.
